(19) United States
(12) Patent Application Publication
(10) Pub. No.: US 2026/0107861 A1
(43) Pub. Date: Apr. 23, 2026

(54) Stake Installation Handtool

(71) Applicant: Michael Magyar, Gibsonia, PA (US)

(72) Inventor: Michael Magyar, Gibsonia, PA (US)

(21) Appl. No.: 19/362,972

(22) Filed: Oct. 20, 2025

Related U.S. Application Data
(60) Provisional application No. 63/710,821, filed on Oct. 23, 2024.

(51) Int. Cl. A01B 1/10; A01B 1/12

(52) U.S. Cl. CPC A01B 1/10; A01B 1/12

(57) ABSTRACT

A soil loosening hand tool having a handle, a shaft, a foot bar, and a broadhead acumination that results in a distal point. This hand tool provides an improved way for a user to loosen the soil so that the stakes of lighting fixtures or other apparatuses can be easily pushed into the ground at a desired and consistent height resulting in light features that are evenly above ground for entire area and design.

This non-provisional application claims priority to U.S. provisional application Ser. No. 63/710,821 entitled Stake Installation Handtool filed on Oct. 23, 2024. All of the content of provisional application 63/710,821 is fully incorporated into this non-provisional application.

### FIELD OF INVENTION

The described invention relates to a soil loosening stake installation hand tool used when it is necessary to install an apparatus with a stake design into the ground. These apparatuses include but are not limited to landscape lighting features.

### BACKGROUND

In landscaping, it is desired to install apparatuses or features into the ground. Many of these items utilize a stake which is used to anchor and lock or secure the apparatus or feature in the soil. These apparatuses can include but are not limited to path lights. Most path lights comprise a lighting feature connected to a stake, a spike, or some sort of anchor for in-ground installation. These in-ground installation features come in a variety of designs, though most come to a point where the feature first touches and leads into the ground before being pushed into the soil to install the feature securely into the ground.

However, depending on the nature status hardness of the soil pushing say a path light fixture into the ground can be a struggle. Especially after a dry spell the ground can be quite hard and/or soil in general can be compacted and results in excessive pushing of the path light fixture. And if the stake made of plastic or the apparatus overall is not well made, sometimes the fixture or apparatus can be damaged or destroyed beyond use. A common stake design is to have 4 projecting flanges that are widest at the top near the lighting feature (the component that should remain above ground) that tapers to a point at the far end away from the light feature that is meant to be the lead guide into the ground/soil. The variations, modifications, and configurations of stakes are too numerous to describe here, even if we limited ourselves to the common 4 flange tapered designs. After the stake is pushed into the ground/soil, the flanges allow the apparatus to become secure in the ground/soil by having the dirt/soil to settle around the stake after it is pushed in. Dirt/soil is not removed or displaced during these ground installations.

What is needed is a hand tool that easily and only utilizes manpower that can loosen (but not displace) the soil such that pushing the apparatus using the stake as the lead guide into the ground. A lightweight but strong hand tool that is easy for a person to carry, easy to use only exerting manpower, and can be used without accessories would be ideal. And while most people would think shovels would be ideal, using a shovel removes the soil (displaces) to create a hole for which the user needs to judge to make a specific depth (the depth needs to match the length of the stake/spike/anchor so that the feature, for example, a lighting feature, is above ground as intended) and then after placing the apparatus in the hole, the soil needs to be replaced and packed back into ground secure the apparatus. Other tools use rotational movement with spiral auger bore/bit to loosen and displace soil, and while this can theoretically be hand tool of sorts, it is most often a motorized rotational movement as from a drill, so that is it easier to push down. Using manpower to push down and rotate the spiral auger like a corkscrew would be time consuming and the user would become tired soon. And with this tool the soil loosening is confined to the area of the spiral auger.

### SUMMARY OF THE INVENTION

Disclosed is a claimed invention for a stake installation hand tool used for loosening soil. The hand tool may be comprised of a handle, a shaft, a foot bar and a broadhead acumination that results in a distal point. The broadhead acumination may be a straight acumination or it may be an angled acumination. The plurality of edges of the broadhead acumination may be smooth or serrated. To operate any embodiments of the hand tool, the user first identifies the position where they want the soil to be loosened, then the user will take the hand tool and push the broadhead acumination into the ground at the desired area. The user will then step on the foot bar pushing the broadhead acumination into the ground until it touches or is in close proximity to the foot bar. At that instance, the user then pushes the handle forward and back, and right to left, several times allowing the broadhead acumination to loosen the dirt or soil the desired position/area. Once the soil/dirt feels loose enough, the user then pulls out the hand tool.

### SHORT DESCRIPTION OF FIGURES

FIG. 1A is a drawing showing a side view of one embodiment of the soil loosening hand tool with a quad-flanged broadhead angled acumination.

FIG. 1B is a close of view of the quad-flanged broadhead angled acumination attachment to the foot bar of the soil loosening hand tool.

FIG. 2 is a drawing showing angled view of the soil loosening hand tool with a quad-flanged broadhead angled acumination.

FIG. 3 is a drawing showing a bottom view of the soil loosening hand tool with a quad-flanged broadhead angled acumination.

FIG. 4A shows the individual long slotted flat plate and the individual short slotted flat plate that makes up the broadhead angled acumination.

FIG. 4B shows a partially assembled broadhead angled acumination.

FIG. 4C shows the fully assembled broadhead angled acumination.

FIG. 5 shows a bottom of an alternative embodiment of the soil loosening hand tool having a serrated quad-flanged broadhead angled acumination.

FIG. 6 shows a bottom of an alternative embodiment of the soil loosening hand tool having a straight edged quad-flanged broadhead acumination.

### DETAILED DESCRIPTION

The claimed invention is for a stake installation hand tool that can be easily used with just manpower (i.e. a person can use it alone without any accessories or mechanical motorization), to loosen dirt/soil in the ground so that apparatuses such lighting fixture stakes can be installed in the ground quick and easy. The streamlined simplified design can be manufactured using known techniques which can cut down on costs and time of producing the product in commercially feasible quantities.

In the landscaping industry especially, installing ground accessories such as low voltage lighting into hard or very solid ground can be challenging. Trying to just push or wiggle in the light can result in uneven heights amongst the various lighting features which look horrible and unprofessional or can actually result in breakage of the lighting fixture. Traditionally, landscapers would just dig a hole that is small in width but deep enough to accommodate the stake, which removes or displaces the soil. Then after adding the fixture with the stake, the soil has to be put back again and packed firm enough to support the light fixture to hold and secure its position. This is a time-consuming process, especially because the landscaper needs to install the light fixtures with spacing in a particular design or pattern to be visually appealing or pleasing to their customers and the installation process may need to be repeated multiple times with one or several of the light fixtures. There needs to be an improvement to the process of loosening the soil so that the stakes of lighting fixtures or other apparatuses can be easily pushed into the ground at a desired and consistent height so that the light features are evenly above ground for entire area and design. And while there are motorized tools that use an auger bore to loosen soil, this requires charging and/or having extra batteries on hand to complete. What is needed is a simplified streamlined hand tool that a typical landscaper can carry and use quickly and efficiently to loosen soil/dirt and push and place the lighting fixtures or other apparatuses into the ground at a consistent height.

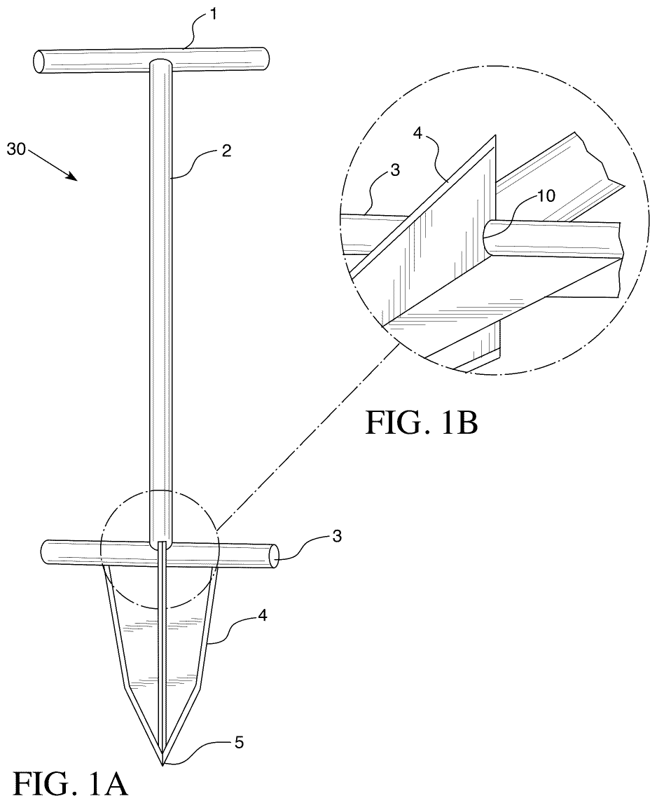

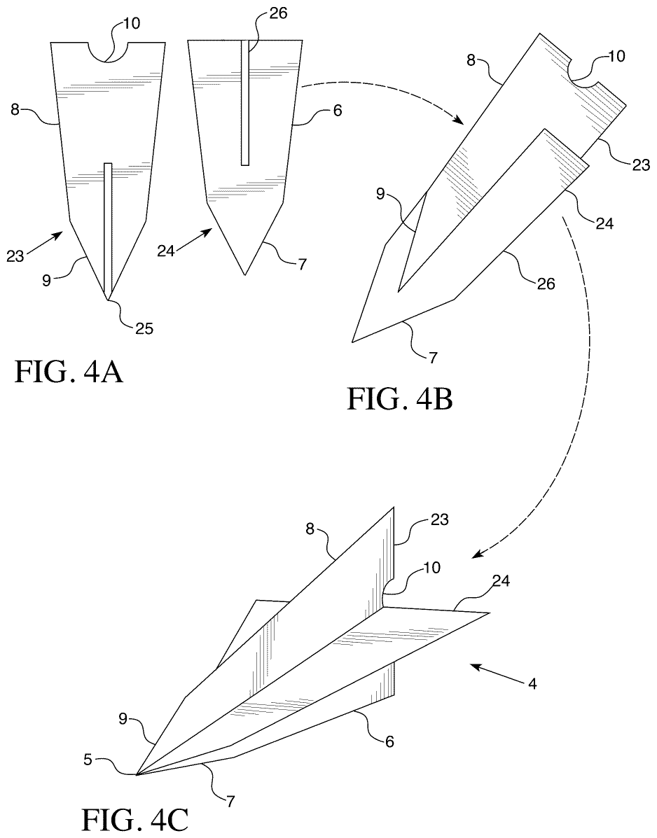

The figures show non-limiting embodiments of the claimed invention, a hand tool that can be used to loosen soil without displacing it, so that an apparatus with a stake can be inserted into the ground soil/dirt easily up to the base of the feature to which it is attached. As can be seen in FIGS. 1A 1B, 2 and 3, the hand tool 30 is comprised of a handle 1, a shaft 2, a foot bar 3 and a quad-flanged broadhead angled acumination 4 which results in a distal point 5 that is pushed into the ground. As is depicted in FIGS. 4A-4C, quad-flanged broadhead angled acumination is comprised of first slotted flat plate 23 and second slotted flat plate 24. First slotted flat plate 23 is comprised of a long edge 8, short edge 9, receptacle 10 and point end slot 25. Second slotted plate 24 is comprised of long edge 6, short edge 7 and rear slot 26. When first slotted plate 23 and second slotted plate 24 are fully assembled via point slot 25 and rear slot 26, quad-flanged broadhead angled acumination 4 is formed with distal point 5. However other means such as welding or any other attachment means known in the art can be used to attach pieces to one another to form the broadhead acumination. One means of connecting quad-flanged broadhead angled acumination 4 to the hand tool 30 is to have foot bar 3 rest in receptacle 10 where physical attachment carried out by any means known in the art including welding,

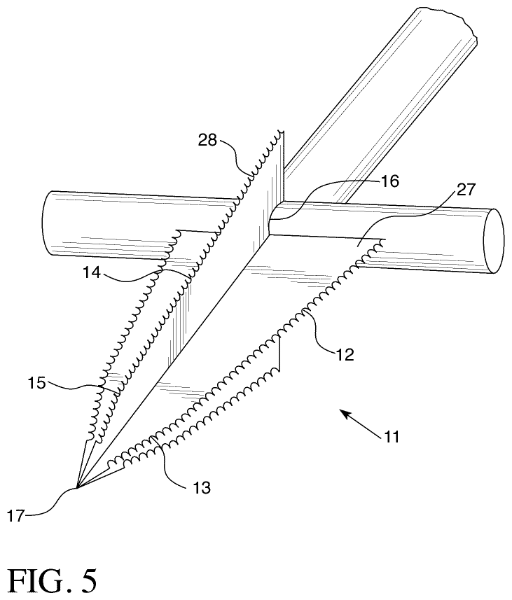

FIG. 5 depicts an alternative embodiment of the soil loosening hand tool having a serrated quad-flanged broadhead angled acumination. Serrated quad-flanged broadhead angled 11 acumination with distal point 17 is comprised of a fully assembled slotted flat plates, a first slotted flat 27 plate is comprised of serrated long edge 12 and serrated short edge 13, and a second slotted plate 28 is comprised of long serrated edge 14, serrated short edge 15, and receptable 16. Assembly is similar to that depicted in FIGS. 4A-4C. Or pieces can be welded or attached by any other known means together to form the broadhead acumination.

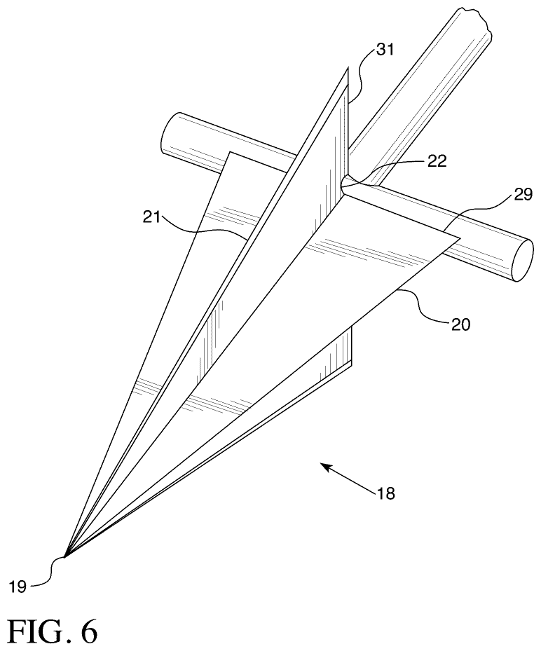

FIG. 6 depicts an alternative embodiment of the soil loosening hand tool having a quad-flanged broadhead straight acumination. quad-flanged broadhead straight acumination 18 with distal point 19 is comprised of a fully assembled slotted flat plates, a first slotted flat plate 29 is comprised of straight edge 20, and a second slotted plate 31 is comprised of straight edge 21, and receptable 22. Assembly can be similar to that depicted in FIGS. 4A-4C. using slots to fully assemble. Or pieces can be welded or attached by any other known means together to form the broadhead acumination. And while depicted here with smooth edges, the broadhead straight acumination may also have serrated edges.

The length of the broadhead acumination for various embodiments can range from 6-16 inches for typical soil loosening and stake installation use. The top width of the individual flanges, the portion that connects with the footrest, for the various broadhead acumination designs can be approximately 2 inches, though any width is contemplated by this disclosure. The angle of the outer surface of an individual flange of a broadhead straight acumination going from the width of the flange distally to the point of the flange will ultimately depend on the length to width ratio. For the designs of the broadhead angled acumination, the outer surface of each individual flange has a more severe angle of 30 degrees starting at about ⅕-1/4 of the length of the outer surface leading away from the distal point.

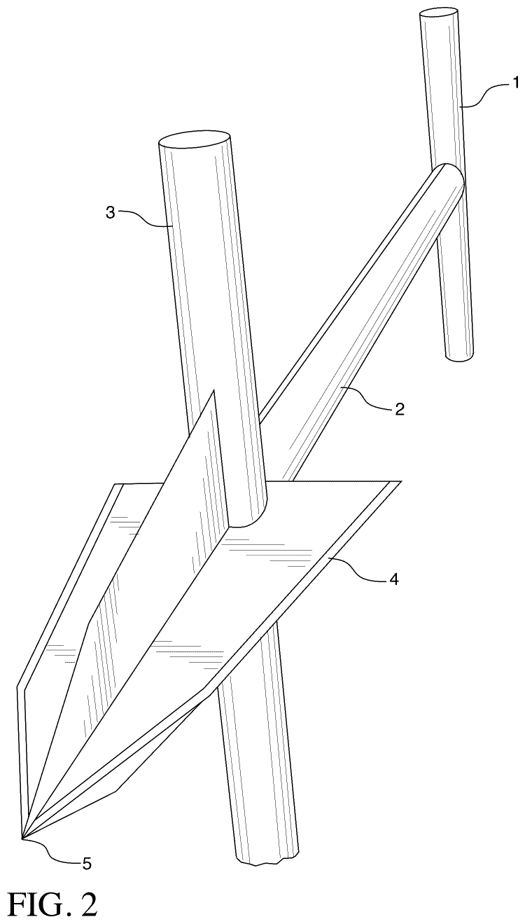

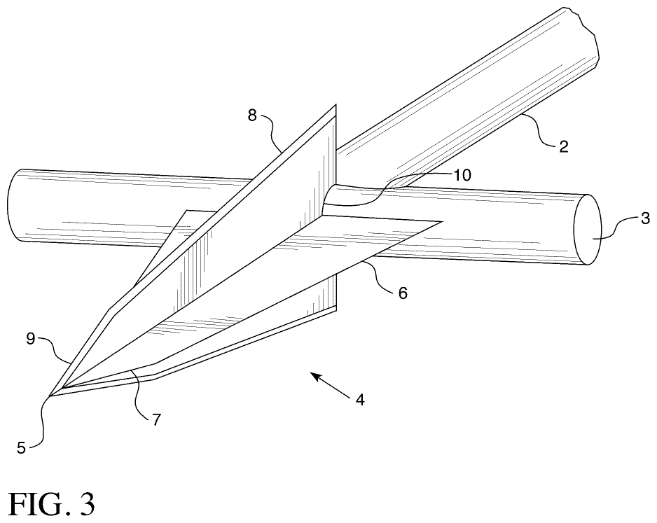

In the non-limiting embodiments depicted here, the broadhead acumination can be comprised of a quad flange component that has four flanges protruding from a central axis having solid outer surfaces at right angles to one another as seen in FIGS. 1-6. It is within the skill of a PHOSITA to create and manufacture alternative embodiments of the broadhead acumination, each having plurality of edges, though most practically would be a broadhead acumination with three edges (tri-flanged) or a broadhead acumination with 5 edges (pent-flanged), whether the edges of either embodiment be angled, serrated or straight edged.

The handle, the foot bar, and the shaft size should be in range to accommodate an adult using the hand tool. Typically, the footrest and handle will be approximately one foot/12 inches in length using ¾ inch pipe, though any feasible diameter pipe may be used. The total length of the hand tool including the broadhead acumination can range from 43-48 inches for a typical adult user. To operate any embodiments of the hand tool, the user first identifies the position where the apparatus with a stake such as light fixture will be placed into the ground, then the user will take the hand tool and push the broadhead acumination into the ground at the desired area. The user will then step on the foot bar pushing the broadhead acumination into the ground until it touches or is in close proximity to the foot bar. At that instance, the user then pushes the handle forward and back, and right to left, several times allowing the broadhead acumination to loosen the dirt or soil the desired position/area. Once the soil/dirt feels loose enough, the user then pulls out the hand tool and then can insert the stake of the apparatus into the ground up to the fixture element with ease. To pack the soil, the user then just needs to step down around the fixture (carefully avoiding the fixture) to repack the soil/dirt.

The components of the hand tool can be connected by welding techniques, these are ideal, non-limiting techniques. The components of the hand tool can be connected to another by any means known in the art that can withstand the amount of force and pressure exerted by user when using the hand tool. The hand tool can be made out of various materials, some common and feasible materials include ¾ mild steel schedule 40 (would require a coating), ¾ inch stainless steel pipe with ⅛ stainless steel plate, or even aluminum for a lighter weight version. If the hand tool is to be covered by a coating, any feasible coating can used, such as coatings to enable grip in the handle, or a coating to prevent rusting (if tool made out of metal), or a coating such as Teflon® can be used on the flanges to prevent ground soil/dirt or other. Hand grips also be used on the handle and foot pad/grips can be used on the foot bar.

The foregoing description merely illustrates the invention and is not intended to be limiting. It will be apparent to those skilled in the art that various modifications can be made without departing from the inventive concept. Accordingly, it is not intended that the invention be limited except by the appended claims.

1. A soil loosening hand tool comprising:
a handle, a shaft, a foot bar, and a broadhead acumination that results in a distal point, wherein the broadhead acumination has a plurality of edges.

2. The hand tool of claim 1, wherein the plurality of edges ranges from 3-5 edges.

3. The hand tool of claim 1, wherein the edges are serrated.

4. The hand tool of claim 1, wherein the edges are smooth.

5. The hand tool of claim 1, where in the broadhead acumination is an angled acumination.

6. The hand tool of claim 5, where the edges each are comprised of a long edge and a short edge.

7. The hand tool of claim 1, where in the broadhead acumination is a straight acumination.

8. The hand tool of claim 1, wherein the broadhead acumination is quad-flanged having four edges, wherein the short edges are configured to form the distal point.

9. The hand tool of claim 8, wherein the broadhead acumination is comprised of a first slotted flat plate and a second slotted flat plate, the first slotted flat plate being comprised of edges and a point end slot, the second slotted plate being comprised of edges and a rear slot, where in the broadhead acumination that results in the distal point is formed by fully assembling first slotted flat plate and the second slotted plate via the point end slot and the rear slot, respectively.

10. The hand tool of claim 8, wherein the edges are smooth.

11. The hand tool of claim 8, wherein the edges are serrated.

12. The hand tool of claim 8, wherein the edges are angled, resulting in an angled acumination.

13. The hand tool of claim 12, wherein the edges each are comprised of a long edge and a short edge, wherein the short edges are configured to form the distal point.

14. The hand tool of claim 1, wherein the broadhead acumination has receptacle for receiving the foot bar to connect the broadhead acumination to the foot bar.

15. The hand tool of claim 9, wherein the first slotted flat plate has receptacle for receiving the foot bar to connect the broadhead acumination to the foot bar.
